(19) United States
(12) Patent Application Publication
(10) Pub. No.: US 2026/0243145 A1
(43) Pub. Date: Aug. 20, 2026

(54) METHOD FOR MODIFYING THE PERMEABILITY OF A GEOLOGICAL FORMATION ZONE

(71) Applicant: IFP ENERGIES NOUVELLES, RUEIL-MALMAISON (FR)

(72) Inventor: David ROUSSEAU, RUEIL-MALMAISON CEDEX (FR)

(21) Appl. No.: 19/544,108

(22) Filed: Feb. 19, 2026

(30) Foreign Application Priority Data
Feb. 20, 2025 (FR) 2501772

(51) Int. Cl. E21B 33/138; C09K 8/42; E21B 37/06

(52) U.S. Cl. CPC E21B 33/138; C09K 8/426; E21B 37/06

(57) ABSTRACT

The invention relates to a distribution process for modifying the permeability distribution of a geological formation zone (3) with different permeabilities between a fluid injection well (1) and a fluid production well (2),
a) a solution containing a hydrophobically associative polymer HAP is injected into the injection well (1) so that said solution plugs the permeability of the low-permeability portions by forming a first HAP gel,
b) a solution containing at least one sol is injected into the injection well (1) so that said sol plugs the permeability of the high-permeability portions (5) left free by forming a second gel,
c) a solution containing a surfactant is injected into the injection well (1), interacting with the first HAP gel so that the permeability plugged in step a) of the low-permeability portions becomes accessible again.

### TECHNICAL FIELD

The invention relates to underground exploitations, notably geothermal exploitations, lithium exploitations (optionally in co-production with geothermal exploitations), and oil production exploitations.

It notably concerns underground exploitations that generally involve combinations of two wells, a first well known as an injection well and a second well known as a production well, separated from each other by a geological formation that has structural heterogeneities (fractures) and/or a distribution of permeabilities.

It more particularly concerns geothermal exploitations: among the different types of geothermal exploitation, the invention focuses on “geothermal doublets” (the first injection wells associated with the second production wells mentioned above) in deep or shallow aquifers, in which heat is transported to the surface by the aquifer's brine. The invention also concerns very deep “high-energy” geothermal systems in hot dry rock or otherwise, known by the acronym “EGS” (“Enhanced Geothermal Systems”), in which the heat-transfer fluid is injected from the surface. The invention may also be applied to geothermal facilities for inter-seasonal heat storage in aquifers, known by the acronym “ATES” (Aquifer Thermal Energy Storage).

These systems, which all include at least one well, a heat-transfer fluid injector, and at least one heat-transfer fluid production well, are liable to suffer reduced energy efficiency due to the effects of excessively rapid hydraulic contact between injection wells and production wells. These effects, known as “hydraulic short circuits”, arise from preferential flow in very permeable zones or in large, open and/or sparingly branched fractures.

They have been described in the literature in the case of aquifer geothermal systems for heat production or ATES: see, for example, the article “Thermal short circuit on groundwater heat pump” by Antonio Calgaro et al., Applied Thermal Engineering, 57 (2013) 107-115). They have also been described in the case of dry hot rock geothermal systems for EGS: see, for example, the article “Multiscale short-circuiting mechanisms in multiple fracture enhanced geothermal systems” by Gee B. et al., Geothermics 94 (July 2021).

The invention also addresses fractured oil reservoirs and their associated issues, such as water ingress prevention, water injection profile control in the vicinity of wells (“injection profile control”) or at depth (“conformance control”), as described, for example, in the article “Gel Treatments for Reducing Channeling in Naturally Fractured Reservoirs” by S. R Seright et al., SPE Production and Facilities Journal Paper, November 1999, volume 14 (4) 269-276.

More generally, the present invention thus concerns techniques for modifying the permeability of geological formations, notably with a view to reducing the permeability of highly permeable zones or fractures responsible for excessively rapid communication between the two wells (preferential flow of the aqueous phase), preferably while modifying as little as possible the permeability of the permeable matrix or of minor fracture zones (i.e. fractures with a small aperture and/or which are highly branched). The aim is thus to achieve flow of the aqueous phase preferentially through the matrix or through minor fracture zones.

### PRIOR ART

Patent FR2933730 discloses a process for restoring the degraded permeability of porous rock, in which the following steps are performed:
said rock is traversed by circulating at least one aqueous solution containing hydrophobically associative polymers known as HAPs
said rock is treated by injecting therein an aqueous solution of at least one surfactant at a specific concentration to break the hydrophobic bonds between the associative polymer chains.

These HAPs thus allow at least a fraction of the pore space to be filled by forming gels therein. However, their distinctive feature is that, by adding appropriate surfactants, the inter-chain bonds responsible for the presence of gels can be drastically reduced, thereby making the parts of the pore space under consideration accessible again: the plugging of porosities with this type of polymer may thus be reversible.

The article “Controlling excess water production in fractured carbonate reservoirs: chemical zonal protection design” by B. Gosh et al., Journal of Petroleum Exploration and Production Technology, Volume 10, pages 1921-1931, (2020), also discloses a technique for combating excess water ingress in complex horizontal wells in the context of oil production, using three successive treatments:
treatment with a fluid comprising suspended calcium carbonate particles combined with viscosifying compounds such as starch or xanthan,
followed by treatment with a fluid which can form a gel, injected in the form of a pre-gel, based on acrylamide and vinylpyrrolidone,
and then an enzymatic treatment that breaks down the cake-forming materials based on starch, xanthan polymer and calcium carbonate particles, using a fluid comprising a mixture of enzymes (xanthanase and amylase).

The efficacy of this method is limited by the kinetics and sensitivity to the operating conditions of the enzymatic reaction process.

The publication “Successful Water Shutoff Treatment of Fractured Carbonate Horizontal Well Under Aquifer Pressure Support” by Hernando L. et al., presented at the Abu Dhabi International Petroleum Exhibition & Conference, Abu Dhabi, United Arab Emirates, on 9 Nov. 2020 (publication number: SPE-203394-MS), describes a process comprising the following injection steps performed on one of the wells in the system to be treated:
injection of microgels to protect the matrix by being adsorbed onto the rock walls;
injection of a polymer pre-gel (a mixture of polymers in aqueous solution and a crosslinking agent). This pre-gel cannot spread readily through the matrix due to the presence of the adsorbed microgels and thus spreads through the fractures;
closing of the well to allow the pre-gel to transform into a gel under the effect of a gelation reaction triggered by the temperature of the underground formation. This has the effect of plugging the fractures, i.e. very greatly reducing their permeability. In this method, the microgels are not removed from the matrix at the end of the operation, but due to their selective permeability reduction property, the permeability of the matrix to oil is not or is only slightly modified. Also, in this method, the microgels cannot, in principle, totally protect the matrix because they are only adsorbed onto the pore walls without plugging them: they thus do not create a perfect barrier to the propagation of the pre-gel.

The aim of the invention is therefore to improve techniques for modifying the permeability distribution (notably selectively) of geological formations, with a view notably to making them more effective and readily usable, particularly in the field of geothermal energy.

### SUMMARY OF THE INVENTION

A first subject of the present invention is a process for modifying the permeability distribution of a geological formation zone having portions of rock material with different permeabilities, including first portions with low permeability and second portions with high permeability, said geological formation zone being located between a fluid injection well and a fluid production well, said process comprising the following successive steps:
a) injecting a solution containing at least one hydrophobically associative polymer HAP into the injection well, so that said solution circulates in said geological formation zone and at least partially plugs the permeability of the first portions of low permeability by forming a first HAP gel,
b) injecting a solution containing at least one sol into the injection well, so that said sol circulates in said zone and at least partially plugs the permeability of the second portions of high permeability left free by forming a second gel,
c) injecting a solution containing at least one surfactant into the injection well (1), said surfactant(s) circulating in said zone and interacting with the first HAP gel so that the permeability plugged in step a) of the first low-permeability portions becomes at least partially accessible to fluids again.

Steps a), b) and c) are performed successively.

Additional optional steps may be inserted into the process sequence, notably before step a), and/or after step c) and/or between steps a) and b) and/or between steps b) and c). These may notably include steps involving the injection of an aqueous solution into the injection well, optionally containing one or more dissolved mineral salts and/or one or more dissolved non-associative (i.e. water-soluble) polymers.

The invention is based on the properties of, on the one hand, aqueous solutions of hydrophobically associative polymers (HAP), or associative polymers, and, on the other hand, interactions between surfactants and HAPs. HAPs are polymers with a hydrophilic backbone but which include, along the chains, small amounts (a few mol %) of hydrophobic monomers which can combine in water in the form of hydrophobic nanodomains, also known as “hydrophobic bonds”. These act as temporary crosslinking points and give HAPs novel properties, notably as regards their rheology. Once in contact with surfactants of the appropriate type and concentration, the viscosity of HAP polymers can be significantly modified, and may notably drop sharply.

In step a) according to the invention, the HAPs will spread throughout the formation's permeabilities and selectively form a gel in the zones of lower permeability, plugging the corresponding permeabilities. In fact, in this step, the low-porosity portions of the rock are those that are useful for transporting the heat-transfer fluid (generally an aqueous solution) in geothermal applications, i.e. in the case of EGSs, from the injection well to the production well through paths that are sufficiently slow and tortuous to allow it to heat up sufficiently when it reaches the production well, or in the case of aquifer geothermal doublets and ATESs, in order to prevent the injected water from affecting the temperature of the produced water. This step (a) is thus intended to temporarily protect these low-permeability sections by making them inaccessible to other chemical solutions/compounds.

In step b), the sol (also known as the pre-gel or “gellant”) will be injected into the injection well and will spread only in the highly permeable zones (or fractures) that remain accessible. The injection will then preferably be stopped for a period of time suited to the properties of the injected sol, this duration preferentially being between a few hours and a few days, in order to allow the sol to gel. In fact, in this step, these highly permeable areas (or fractures), which are at least partially responsible for “hydraulic short circuits” between the injection well and the production well, are plugged, causing the heat-transfer fluid to circulate too quickly/through overly direct paths between the injection well and the production well, and thus preventing it from reaching the required temperature in the case of EGSs, or, in the case of aquifer geothermal doublets and ATESs, creating a connection between the injection point and the production point, which causes a drop in the temperature of the water produced.

In step c), the surfactant will modify the rheology of the HAP gel lodged in the lower permeability portions (this HAP gel becoming at least partially a sol again), making them again accessible to the heat-transfer fluid, whereas the high permeability portions (or fractures) remain plugged by the other gel deposited in step b) from a sol.

After these three steps, a geological formation between the two wells is thus obtained that is “repaired”, in the sense that geothermal exploitation can be resumed with a heat-transfer fluid which will circulate from the first well to the other predominantly, or even exclusively, via the low-permeability portions, with the high-permeability portions (or fractures), which are inaccessible, being “bypassed” by the heat-transfer fluid. In the case of EGSs, this will allow the injected heat-transfer fluid to remain in contact with the rock long enough to reach the desired temperature. And in the case of aquifer geothermal doublets and ATESs, this will greatly limit the risk of reinjected water affecting the temperature of the produced water.

Naturally, this treatment may be repeated during exploitation if necessary, notably if the gel contained in the highly permeable portions (or fractures) ages, disintegrates, and makes the highly permeable portions (or fractures) at least partially accessible to the heat-transfer fluid again.

Advantageously, in step b), the sol may form a gel through a gelation reaction that may be spontaneous or activated by a physical parameter, notably by heat supply, or by a chemical activator. The heat may be natural, from the underground formation, or the solution containing the sol may be heated before/during injection.

The first portions with low permeability may correspond to a network of secondary fractures (or microfractures, induced and/or natural) and/or a matrix region, whose permeability may be, for example, in the range from 0.1 mD to 1000 mD.

The second portions with high permeability may correspond to a network of major fractures (induced and/or natural) and/or zones with high permeability, for example in the range from 1 mD to 100 D, or 1 mD to 1000 D or 100 mD to 1000 D. The ratio between the permeability of the high permeability zone and that of the low permeability zone may thus, for example, be between 10 and 106.

In these various ranges, the permeability of the first portions with low permeability is always lower than that of the second portions with high permeability.

The hydrophobically associative polymer HAP injected in step a) may comprise chains formed from hydrophilic monomers and hydrophobic monomers, with the total mole fractions of hydrophobic monomers preferably being between 0.05% and 10%, notably between 0.1% and 3%.

One or more different types of HAP polymer may be used as a mixture.

Their molar masses are preferably between 103 and 108 g/mol.

Advantageously, the sol injected in step b) may be chosen from at least one of the following compounds:
water-soluble polymers, notably of the polyacrylamide type, in solution and a crosslinking agent, which may be organic or inorganic,
particles, notably of colloidal silica, which are capable of forming bonds between themselves, with or without a crosslinking agent,
hydrophobically associative polymers HAP that are insensitive to the surfactant(s) injected in step c) (optionally with a crosslinking agent).

The term “insensitive” to surfactants means that if an HAP is chosen at this stage, it must specifically remain unchanged when it comes into contact with the surfactants in step c) and, in particular, essentially retain its viscosity, or more precisely its rheology as a gel.

Advantageously, the surfactant injected in step c) may be chosen from at least one of the following compounds:
polyethoxylated fatty alcohols,
ethoxyalkyl sulfate alkali metal salts,
alkyltrimethylammonium bromides.

Preferably, solutions containing
the hydrophobically associative polymer HAP injected in step a)
and/or the sol injected in step b)
and/or the surfactant injected in step c) may be aqueous solutions, optionally containing dissolved mineral salts.

The concentration of surfactant(s) in the solution injected in step c) may be determined as a function of the critical micelle concentration CMC of said surfactant(s).

The concentration of surfactants may be close to the critical micelle concentration of the surfactant.

The concentration of surfactants may be between 2 and 5 times the critical micelle concentration of the surfactant.

As described in the abovementioned patent FR2933730, interactions between the hydrophobic parts of surfactants and the hydrophobic groups of the HAPs are responsible for significant changes in the rheological properties of the HAP solutions. As a function of the concentration of surfactants in the HAP solution, two regimes may be distinguished:
at low concentrations, surfactant molecules tend to combine with the hydrophobic groups of the chains and to reinforce the hydrophobic bonds. This results in an increase in the viscosity of the HAP solution;
when the surfactant concentration reaches and exceeds a certain value, for example of the order of magnitude of the critical micelle concentration of the surfactant measured in the absence of HAP, a maximum and then a reduction in viscosity are observed. At even higher surfactant concentrations, the viscosity reaches a plateau value, which is lower than the initial viscosity of the HAP solution without surfactants. This behaviour is interpreted as the formation of mixed micelles between hydrophobic groups in the chains and surfactant molecules. When the surfactant concentration increases, the surfactant molecules become increasingly dominant in the micelles, until there is only one hydrophobic group per micelle. The hydrophobic bonds between polymer chains, whether intra- or inter-chain, thus disappear, and the viscosity of the solution approaches that of a solution of non-associative polymers with a backbone equivalent to that of the HAPs.

Step a) of injecting the solution containing at least one hydrophobically associative polymer HAP may be preceded by a step a0) of injecting an aqueous solution without adding any chemical compounds other than any dissolved mineral salts and/or a step a0′) of injecting an aqueous solution comprising dissolved non-associative polymers and possibly dissolved mineral salts.

Step a) may also be followed by a step a1) of injecting an aqueous solution without adding any chemical compounds other than any dissolved mineral salts, and/or a step a1′) of injecting an aqueous solution comprising dissolved non-associative polymers and possibly dissolved mineral salts.

Step b) of injecting the sol may be preceded by a step b0) of injecting an aqueous solution without adding any chemical compounds other than any dissolved mineral salts, and/or a step b0′) of injecting an aqueous solution comprising dissolved non-associative polymers and possibly dissolved mineral salts.

Step b) may also be followed by a step b1) of injecting an aqueous solution without adding any chemical compounds other than any dissolved mineral salts, and/or a step b1′) of injecting an aqueous solution comprising dissolved non-associative polymers and possibly dissolved mineral salts.

Step c) of injecting the solution containing at least one surfactant may be preceded by a step c0) of injecting an aqueous solution without adding any chemical compounds other than any dissolved mineral salts, and/or a step c0′) of injecting an aqueous solution comprising dissolved non-associative polymers and possibly dissolved mineral salts.

Step c) may also be followed by a step c1) of injecting an aqueous solution without adding any chemical compounds other than any dissolved mineral salts, and/or a step c1′) of injecting an aqueous solution comprising dissolved non-associative polymers and possibly dissolved mineral salts.

A subject of the invention is also the use of the process described above for reducing or eliminating hydraulic short circuits between the injection well and the production well through a geological formation zone.

A subject of the invention is also the use of the process described above for geothermal exploitation, notably
for deep or shallow aquifer systems (where water is already present in the rock, and additional water may be injected and/or water coming out of the production well may be reinjected)
for very deep high-energy geothermal systems, notably in hot dry rock, known as EGSs (in which water is injected from outside and optionally reinjected once extracted from the production well)
for geothermal facilities for inter-seasonal heat storage in aquifers, known as ATESs, or for the exploitation of oil deposits, notably via a technique known as enhanced oil recovery (EOR).

The process according to the invention allows the permeability of very permeable/porous zones or fractures responsible for rapid communication between the two wells to be reduced by at least a factor of 8 or preferably at least a factor of 10, whereas the permeability reduction factor of the permeable matrix or of minor fracture zones must be as close as possible to 1 (no change in permeability) and preferentially less than 100.

### LIST OF FIGURES

FIG. 1 represents a scheme of a vertical cross section of a geological formation between an injection well and a production well, according to step a0) of water injection according to the treatment process of the invention.

FIG. 2 represents a scheme of the same cross section as in FIG. 1, according to step a) of injecting an HAP solution according to the treatment process of the invention.

FIG. 3 represents a scheme of the same cross section as in FIG. 1, according to step b) of injecting a sol (or pre-gel) solution according to the treatment process of the invention.

FIG. 4 represents a scheme of the same cross section as in FIG. 1, according to step c) of injecting a surfactant solution according to the treatment process of the invention.

FIG. 5 represents a scheme of the same cross section as in FIG. 1, according to step d) of injecting water according to the treatment process of the invention.

FIG. 6 is a graph representing the shear rate in units of s⁻¹ in Example 1 as a function of the relative viscosity (i.e. the ratio between the viscosity of the solution and the viscosity of the aqueous phase without dissolved polymer) of polymers denoted HAP, such as those used in step a) of the treatment process of the invention, compared with that of equivalent but non-associative polymers denoted P and with that of HAP polymers associated with a surfactant and denoted HAP′.

FIG. 7 is a graph representing the number of pore volumes injected PVI in Example 1 (i.e. the ratio between the volume of fluid injected and the pore volume of the rock core used in the experiment, without units) of different fluids, and on the y-axis the normalized pressure drop Rm (or aqueous phase mobility reduction factor) of a sample representative of a geological formation, during steps a) and b) of the treatment process according to the invention.

FIG. 8 shows a view of the sandstone core used in the test of Example 2, during sawing to create a fracture, and after sawing to enable the fracture to remain open.

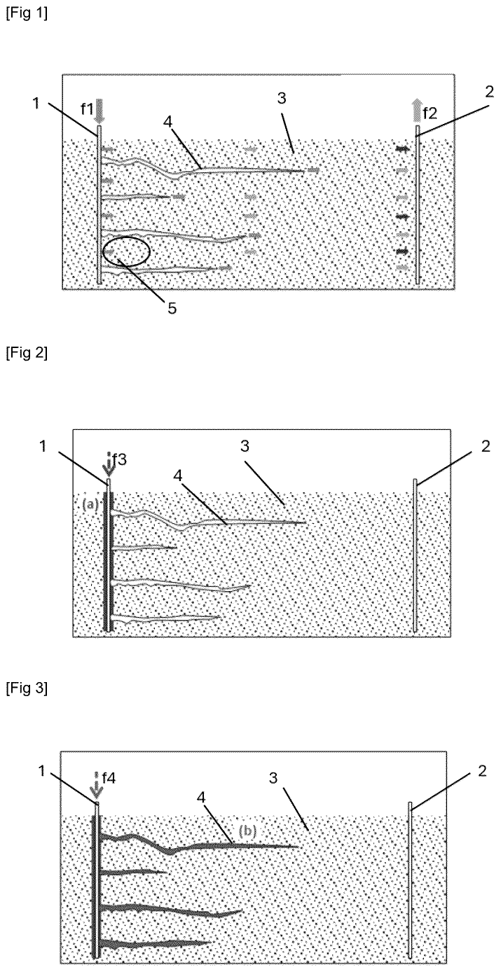

FIGS. 1 to 5, which represent the sequence of steps of an embodiment of the process according to the invention, are highly schematic and not to scale, so as to be clear.

The same components have the same references from one figure to another.

### DESCRIPTION OF THE EMBODIMENTS

The process according to the invention will be described hereinbelow in greater detail, according to non-limiting illustrative embodiments.

### Products Concerned and Operating Conditions

### HAP Polymers

The invention uses HAP polymers in the broad sense, which may be formed by a wide variety of hydrophilic monomers and hydrophobic monomers, and which may be prepared by various methods.

Among the synthetic methods, mention may be made of post-modification, which consists in grafting hydrophobic groups onto pre-existing hydrophilic polymer chains (see the article “Hydrophobically associating polyacrylamides and their partially hydrolysed derivatives prepared by post-modification. 1. Synthesis and characterization”. Polymer, 43-7, 2055-2064, Feng et al., 2002), and micellar copolymerization, which consists in simultaneously polymerizing hydrophilic monomers and hydrophobic monomers in aqueous solution, the latter being dissolved in micelles (see the article “Micellar copolymerization of associative polymers: Study of the effect of acrylamide on sodium dodecyl sulfate-poly(propylene oxide) methacrylate mixed micelles”. Journal of Colloid and Interface Science, 289-2, 359-370, Bastiat et al., 2005).

The molar mass of the HAP polymers may be between about 103 and about 108 g/mol.

The chains consist of one or more types of hydrophilic monomers and one or more types of hydrophobic monomers.

The total mole fractions of hydrophobic monomers may range between about 0.05% and about 10%, preferentially between 0.1% and 3%.

Below is a non-exhaustive list of hydrophilic monomers that can be used: acrylamide, methacrylamide, 2-acrylamido-2-methylpropanesulfonic acid (AMPS), acrylic acid, N,N-dimethylacrylamide, dimethylaminoethyl methacrylate (DMAEMA), dimethylaminopropylmethacrylamide, hydroxyethyl acrylate (ethylene glycol monoacrylate), vinylpyrrolidone and trimethylammoniummethyl methacrylate chloride.

In the case of HAP synthesis by post-modification, the pre-existing hydrophilic chains may be of different chemical types, including all the polymers obtained by polymerizing one or more of the types of monomers mentioned above, and also, without implied limitation: polyethylene oxide (or polyethylene glycol), cellulose ethers (such as hydroxyethylcellulose), natural polysaccharides (such as guar gum), and polyvinyl alcohol.

Examples of hydrophobic monomers that may be used include, but are not limited to, the following groups: alkyl acrylates, alkyl methacrylates, alkylacrylamides, alkylmethacrylamides, dimethylammoniummethyl methacrylate alkyl bromides, dimethylammoniummethyl methacrylate alkyl chlorides, dimethylammoniummethyl methacrylate alkyl iodides, dimethylammoniumpropylmethacrylamide alkyl bromides, dimethylammoniumpropylmethacrylamide alkyl chlorides, and dimethylammoniumpropylmethacrylamide alkyl iodides. The alkyl chains may be branched or unbranched and may comprise between about 4 and 25 carbon atoms.

### Surfactants

The invention is not limited to surfactants of a particular chemical nature. Surfactants are systems made up of one or more types of molecules that have surfactant properties in the broad sense.

They may be ionic or nonionic.

Examples of families of surfactant molecules include, in a non-limiting manner: polyethoxylated fatty alcohols, ethoxyalkyl sulfate alkali metal salts and alkyltrimethylammonium bromides.

### Sols (Pre-Gels)

The invention relates, without limitation as to the chemical or physical nature, to all types of gels, i.e. gels in any type of solvent, resulting from the gelation of sols, also known as pre-gels.

The gels are preferentially hydrogels, preferentially consisting either of a water-soluble polymer (for example of the polyacrylamide type) in solution and of a crosslinking agent, or of particles (for example of colloidal silica) that are capable of forming bonds between themselves with or without crosslinking agents, or HAPs that are capable of forming gels in areas of high permeability and that are not sensitive to the surfactants injected in the context of the method according to the invention.

Polymer hydrogel formulations may, for example, be made up, on the one hand, of polymers based on polyacrylamide bearing acrylate and/or acrylic acid and/or sulfonated units (such as 2-acrylamido-2-methylpropanesulfonic acid) and/or N-vinylpyrrolidone and, on the other hand, of crosslinking agents in the form of a complex/complexes of multivalent metal ions such as zinc, chromium, titanium, zirconium and aluminium (initially complexed, for example, in the form of chlorides, acetates or lactates), thus forming physical gels with ionic bonds.

### Aqueous Solutions

The HAPs, surfactants and hydrogels may be dissolved in water containing dissolved salts. The concentration of these salts may range from 0 g/L to saturation, i.e. for example 357 g/L for NaCl at 25° C.

The pH of aqueous solutions of HAP and surfactant may be between 3 and 12.

### Process According to the Invention

The treatment process according to the invention is described in FIGS. 1 to 5.

In this embodiment, the invention relates to geothermal systems consisting of at least one well pair, i.e. at least one well 1 for injecting water used as a heat-transfer fluid and at least one well 2 for producing water used as a heat-transfer fluid, which are drilled into an underground heat reservoir formed by a geological formation. In the case of EGSs, the heat-transfer fluid circulates from the first well 1 to the second well 2 through a zone of the geological formation 3 located between the two wells, and in the case of aquifer geothermal systems or ATESs, the heat-transfer fluid is extracted by well 2 and reinjected by well 1, so that the circulation of this fluid through the geological formation is minimal.

In the case where a hydraulic short circuit is present, in the initial state (FIG. 1), cold water (arrow f1) is injected into injection well 1 and circulates in zone 3 towards production well 2, preferentially via a network of major fractures 4 and/or zones of high permeability 5, so that the temperature of the water produced by production well 2 is lower than that required for satisfactory operation of the system.

This procedure relates both to aquifer geothermal systems and ATESs (where the heat-transfer fluid is aquifer brine) and to EGSs (where the heat-transfer fluid is water injected from the surface).

This situation also corresponds to cases involving the exploitation of fractured oil reservoirs, to which the process according to the invention may also be applied. This is step a0) mentioned above.

In a first step of the method (FIG. 2), i.e. step a) mentioned above, an HAP solution is injected through the injection well 1 (arrow f3). The HAP penetrates all areas of zone 3 of the geological formation, but does not form a gel in the network of major fractures 4 and/or areas of high permeability 5 due to their excessive permeability.

However, it does form a gel in the matrix zone and/or the network of secondary fractures (i.e. fractures with a small aperture and/or that are highly branched, not shown in the figure), if the associated permeability is sufficiently low. This allows protection of these zones from invasion by other chemical additives. The HAP is, for example, a partially sulfonated polyacrylamide (for example with 5 mol % of sulfonated monomers) whose associative character comes from the presence of alkyl side chains (for example with 12 carbons) borne by a certain portion of the acrylamide monomers (for example 0.5 mol %).

In a second step of the method (FIG. 3), i.e. step b) mentioned above, a sol (or pre-gel, also called a “gellant”), which is capable of forming a gel, is injected through the injection well 1 (arrow f4). Due to the presence of the protective HAP gel in the matrix zone and/or the network of secondary fractures, this pre-gel spreads essentially in the network of major fractures 4 and/or the high permeability zones 5.

The injection of any fluid is then interrupted so as to allow the sol/pre-gel to form a gel that greatly reduces the permeability (by a factor of at least 5, 8 or preferably at least 10) of the major fracture network and/or high permeability zones.

The formation of the gel may, for example, be the result of a gelation reaction with more or less slow kinetics or of activation by a physical parameter (for example temperature) or by a chemical agent known in the prior art.

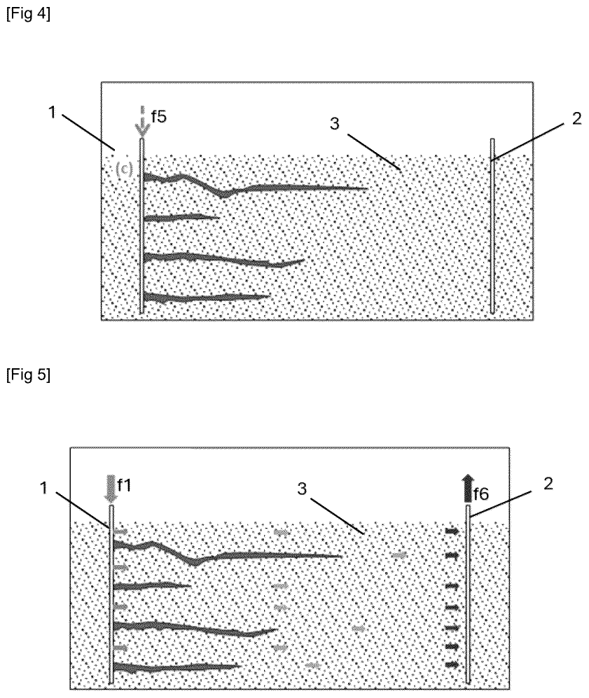

In a third step of the method (FIG. 4), i.e. step c) mentioned above, a surfactant solution (arrow F5) designed to interact with the HAPs injected in step a), so that it breaks the interchain hydrophobic bonds of the HAPs, and thus the HAP gel formed in the matrix zone and/or in the network of secondary fractures. The surfactant may, for example, be an alkyl glyceryl ether sulfonate (AGES) with 7 carbon atoms in the hydrophobic part and, in the hydrophilic part, 7 propoxy (PO) groups and 9 ethoxy (EO) groups.

This has the effect of restoring the permeability of the matrix zone and/or the secondary fracture network, so that the permeability reduction factor is as close as possible to 1 (no change in permeability) and preferentially less than 100.

In the final state of the system (FIG. 5), cold water is injected again (arrow f1) into injection well 1 (step d) described previously). This water circulates in the matrix zone and/or the network of secondary fractures in such a manner that it reaches production well 2 (arrow f6) at a temperature sufficient to allow the system to operate satisfactorily (in the case of EGSs) or to have no influence on the temperature of the water produced by the production well (in the case of aquifer geothermal systems or ATESs): the geothermal capacities of geological formation 3 can thus be exploited again under optimized operating conditions.

### Example 1: HAP in a Porous Matrix Medium

The first example is a test involving the injection of an HAP polymer solution into a porous matrix medium, showing that an HAP can form a stable gel in a matrix formation, leading to its virtual plugging, and that this gel can disappear under the effect of the injection of a surfactant solution.

In this example, the HAP chosen is a terpolymer consisting of 94.5 mol % acrylamide monomers, 5 mol % sulfonated monomers and 0.5 mol % acrylamide-type monomers bearing hydrophobic side groups consisting of linear alkyl chains with 12 carbon atoms. The HAP is in solution at 2.5 g/L in a brine containing 20 g/L NaCl.

In this example, the surfactant is an alkyl glyceryl ether sulfonate (AGES) with 7 carbon atoms in the hydrophobic part and, in the hydrophilic part, 7 propoxy (PO) groups and 9 ethoxy (EO) groups. The surfactant is in solution at 1 g/L in a brine containing 20 g/L NaCl. Its concentration is adjusted in a manner known to those skilled in the art relative to that of the HAP.

The porous medium is a granular mass consisting of quartz grains with a permeability of 200 mD and a porosity of 31%, initially saturated with a brine containing 20 g/L NaCl.

The sample-holding cell for the porous medium is fitted with upstream and downstream pressure tappings as well as intermediate pressure tappings, so that pressure losses (pressure gradient) may be determined over the total length of the porous medium (i.e. 10 cm) as well as over an intermediate inlet section 1 cm in length (“0-1 cm”) and on an internal section 4 cm long ranging from the first to the fifth cm of the porous medium (“1-5 cm”).

The observable is the normalized pressure drop denoted “Rm” (or aqueous phase mobility reduction factor), calculated for each section by dividing the pressure drop during the various injection stages of the test by the reference pressure drop determined during the injection of brine, at the same flow rate, in the initial state of the porous medium.

All the fluids are injected using volumetric pumps at a flow rate corresponding to an interstitial flow velocity of 0.4 m/day. All the steps of the test are performed at a set temperature of 30° C.

The results presented in FIG. 7 show the Rm values determined during the test as a function of the number of pore volumes injected (PVI) of the different fluids. They show that:
during step (1) of HAP injection, a very large reduction in permeability is obtained over the 0-1 cm section (Rm of about 30 000) but not at depth. Since the relative viscosity of the HAP solution is less than 30 regardless of the rate gradient, this indicates that an HAP gel forms upstream of the porous medium. It is also observed that this gel does not propagate at depth, since the Rm value remains about 1 over the 1-5 cm section;
during step (2) of injection of brine containing 20 g/L NaCl, the gel is maintained with an Rm value close to 10 000 over the 0-1 cm section after about 4 PVI of brine. This indicates that the permeability is stably reduced by a factor of 10 000 over the inlet section. The desired protective effect of the matrix is thus obtained;
during step (3) of surfactant injection, the gel disappears since the Rm value over the 0-1 cm section reduces sharply to reach 20 after about 1.5 PVI of surfactant, this value not being stabilized and still reducing at the end of the test. This demonstrates that the effect of restoring the permeability of the matrix zone may be obtained by means of the process according to the invention.

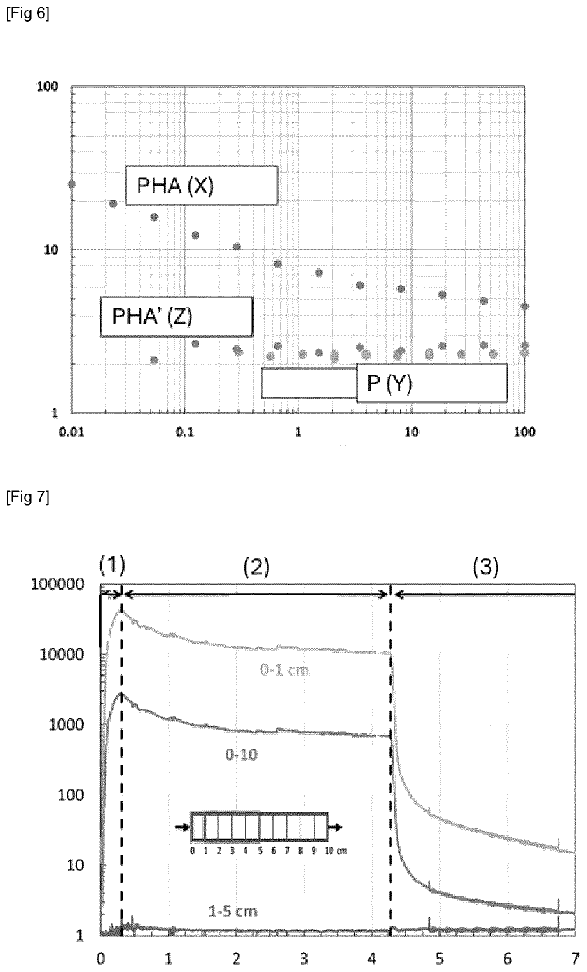

Prior to the test, the results of which are shown in the graph in FIG. 7, a viscometry study was performed using a commercially available Low Shear LS300 viscometer from the company ProRheo, the results of which are represented in the graph in FIG. 6.

The measurements were taken at 30° C. on three solutions:
an aqueous solution X of HAP polymer according to the example, at 2.5 g/L
an aqueous solution Y of equivalent non-associative polymer P (i.e. a polymer identical to HAP, except that it does not bear a hydrophobic group), at a concentration of 2.5 g/L
an aqueous solution Z with the HAP of solution X, at 2.5 g/L, supplemented with the surfactants from the example at a concentration of 1 g/L.

The test was performed using a granular pack (composition and results given in Table 1 hereinbelow) prepared dry with grains of sand in a sample holder equipped with taps to measure the pressure at different points in the sample holder cell body, which makes it possible to determine the pressure drops across intermediate sections of the porous medium. The porous medium has a total length of 10.2 cm and the pressure differences (ΔP) were able to be determined with differential pressure sensors over the total length, a 1 cm long inlet section (“0.1 cm section”) and a 4 cm long internal section (“1 to 5 cm section”). Brine and brine with solutes (polymer and/or surfactant) were injected at low flow rates (representative of typical deep flow in reservoirs) using two commercially available QX 6000 volumetric pumps from the company Quizix.

In the first step of the experiment (1), a volume of HAP solution equal to 0.3 pore volumes was injected so as to demonstrate that HAP injection leads to the formation of a temporary resistant gel.

In the second step (2), a volume of brine equal to 4 pore volumes was injected to evaluate the “irreversible” nature of the gel.

In the third and final step (3), a volume of surfactant solution equal to 3 pore volumes was injected so as to evaluate the surfactant's ability to disrupt the temporary gel and restore permeability.

TABLE 1

| | Mineralogy | | |
|---|---|---|---|
| | Granular mixture of 85% by weight Fontainebleau sand | | |
| | (110 μm median grain size) and 15% by weight BCR-067 | | |
| | reference quartz grains (mean grain size 10 μm) | | |
| Permeability | | Pore | |
| (mD) | Porosity (%) | volume (mL) | Length (cm) |
| 230 | 31 | 5.6 | 10.2 |

| Temperature | Brine | Interstitial injection |
|---|---|---|
| (° C.) | composition | velocity (m/day) |
| 30 | 20 g/L NaCl | 0.44 |

As shown in the graph in FIG. 6, the relative viscosity of the HAP is significantly higher than that of the equivalent non-associative polymer P. However, when the surfactant is added to the HAP solution (mixture labelled HAP′), its viscosity drops to values very close to that of the equivalent non-associative polymer P.

This result constitutes a good indication of the “disruptive” role of the surfactant with respect to the hydrophobic bonds of the HAP polymer.

### Example 2: Sol-Gel in a Fractured Porous Medium

The second example is a test involving the injection of a sol formulation into an artificially fractured core. During this test, the formulation spreads through the fracture, transitions to a gel phase after a resting period, and thus plugs the fracture.

After gel formation, the measured permeability of the core is very close to the matrix permeability of the core before fracturing.

In this example, the sol consists of partially sulfonated polyacrylamide (25 mol % 2-acrylamido-2-methylpropanesulfonic acid) at a concentration of 10 g/L and zirconium lactate at a concentration of 500 mg/L. These two compounds are dissolved in a brine, the composition of which is shown in Table 2 below.

TABLE 2

| Ion | Concentration (mg/L) |
|---|---|
| Na⁺ | 25 450 |
| K⁺ | 3,245 |
| Ca²⁺ | 8,000 |
| Mg²⁺ | 144 |
| Li⁺ | 173 |
| Sr²⁺ | 424 |
| Cl⁻ | 57,411 |
| Total dissolved solids | 94,847 |

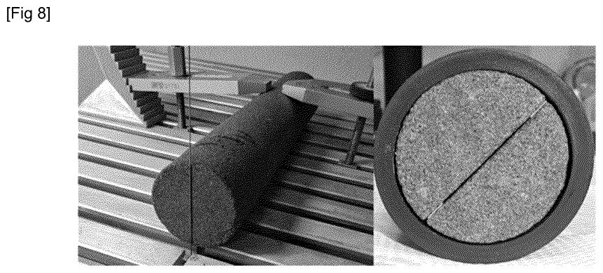

The porous medium consists of a 20 cm long, 4 cm diameter core of Buntsandstein sandstone in which an artificial fracture is created by sawing lengthwise through the core and held open using a 200 μm thick PEEK (polyether ether ketone) slide (FIG. 8). The test is performed at 85° C. During all the injection stages of the test, the core is placed in a Vitton rubber sleeve, which is itself placed in a Hassler-type sample-holder cell, with a confinement pressure set at 60 bar and a pore pressure set at 5 bar.

The test steps are as follows:
(a) determining the matrix permeability of the core in its initial state;
(b) cutting the core into two halves along its main axis using a wire saw;
(c) inserting 200 μm thick PEEK slides to ensure that the fracture remains open under pressure during the experiment;
(d) determining the permeability of the plug with the artificial fracture open
(e) injecting the sol formulation using a syringe;
(f) circulating brine over the pistons and upstream and downstream pipes (using double apertures at the ends of the pistons, allowing brine to circulate over the inlet and outlet sides of the core) to ensure that the sol remains only inside the fracture;
(g) observing a resting period at 85° C. for 72 hours to allow the sol-gel transition to occur (the duration was defined to be representative of the time required to achieve a gel, based on tube tests);
(h) injecting synthetic brine, initially at a low flow rate (set, by convention, at 3 mL/h, corresponding to an interstitial velocity vi of 0.3 m/day, representative of deep flow conditions) to check whether the fracture is blocked by the gel, and then at variable flow rates (up to 200 mL/h, corresponding to vi of 21 m/day, which should be representative of maximum velocities near the well) to determine the permeability.

Table 3 below shows the permeability values of the core determined in its initial state (step a), after fracturing (step d) and after the gel has formed (step h). Since the permeability in step (h) is very close to that in step (a), the results demonstrate the efficacy of a polymer gel in plugging a fracture.

TABLE 3

| | Permeability |
|---|---|
| Test step | (mD) |
| (a) (initial state of the core) | 51 |
| (d) (open fracture) | 8000 |
| (h) (fracture plugged with a gel) | 44 |

1. Process for modifying the permeability distribution of a geological formation zone that has portions of rock material with different permeabilities, including first portions with low permeability and second portions with high permeability, said geological formation zone being located between a fluid injection well and a fluid production well, said process comprising the following successive steps:
a) injecting a solution containing at least one hydrophobically associative polymer HAP into the injection well, so that said solution circulates in said geological formation zone and at least partially plugs the permeability of the first portions of low permeability by forming a first HAP gel,
b) injecting a solution containing at least one sol into the injection well so that said sol circulates in said zone and at least partially plugs the permeability of the second portions of high permeability-left free by forming a second gel,
c) injecting a solution containing at least one surfactant into the injection well, said surfactant(s) circulating in said zone and interacting with the first HAP gel so that the permeability plugged in step a) of the first low-permeability portions becomes at least partially accessible to fluids again.

2. Process for modifying the permeability distribution of a geological formation zone according to claim 1, characterized in that, in step b), the sol forms a gel through a spontaneous gelation reaction or a reaction activated by a physical parameter, notably by the supply of heat, or by a chemical activator.

3. Process for modifying the permeability distribution of a geological formation zone according to claim 1, characterized in that:
the first portions of low permeability correspond to a network of secondary fractures and/or a matrix region
the second portions of high permeability correspond to a network of major fractures and/or to matrix zones with high permeability.

4. Process for modifying the permeability distribution of a geological formation zone according to claim 1, characterized in that the hydrophobically associative polymer HAP injected in step a) comprises chains formed from hydrophilic monomers and hydrophobic monomers, the total mole fractions of hydrophobic monomers preferably being between 0.05% and 10%, notably between 0.1% and 3%, and their molar masses preferably being between 103 and 108 g/mol.

5. Process for modifying the permeability distribution of a geological formation zone according to claim 1, characterized in that the sol injected in step b) is chosen from at least one of the following compounds:
water-soluble polymers, notably of the polyacrylamide type, in solution and a crosslinking agent, which is notably organic or inorganic,
particles, notably of colloidal silica, which are capable of forming bonds between themselves with or without a crosslinking agent,
hydrophobically associative polymers HAP that are insensitive to the surfactant(s) injected in step c).

6. Process for modifying the permeability distribution of a geological formation zone according to claim 1, characterized in that the surfactant injected in step c) is chosen from at least one of the following compounds:
polyethoxylated fatty alcohols,
ethoxyalkyl sulfate alkali metal salts,
alkyltrimethylammonium bromides.

7. Process for modifying the permeability distribution of a geological formation zone according to claim 1, characterized in that the solutions containing
the hydrophobically associative polymer HAP injected in step a)
and/or the sol injected in step b)
and/or the surfactant injected in step c) are aqueous solutions, optionally containing dissolved mineral salts.

8. Process for modifying the distribution and permeability of a zone of a geological formation according to claim 1, characterized in that the concentration of surfactant(s) in the solution injected in step c) is determined as a function of the critical micelle concentration CMC of said surfactant(s).

9. Process for modifying the permeability distribution of a geological formation zone according to claim 1, characterized in that it comprises at least one additional step of injecting into the injection well an aqueous solution, optionally comprising one or more dissolved mineral salts and/or one or more dissolved non-associative polymers,
the additional step(s) notably being performed before step a), and/or after step c) and/or between steps a) and b) and/or between steps b) and c).

10. Process for modifying the permeability distribution of a geological formation zone according to claim 1, characterized in that:
step a) of injecting the solution containing at least one hydrophobically associative polymer HAP is preceded by a step a0) of injecting an aqueous solution without adding any chemical compounds other than any dissolved mineral salts and/or a step a0′) of injecting an aqueous solution comprising dissolved non-associative polymers and possibly dissolved mineral salts and/or
step c) of injecting the solution containing at least one surfactant is followed by step c1) of injecting an aqueous solution without adding any chemical compounds other than any dissolved mineral salts and/or a step c1′) of injecting an aqueous solution comprising dissolved non-associative polymers and possibly dissolved mineral salts.

11. Use of the process according to claim 1 for reducing or eliminating hydraulic short circuits between the injection well and the production well through a geological formation zone.

12. Use of the process according to claim 1 for geothermal exploitation, notably:
for deep or shallow aquifer systems,
for very deep high-energy geothermal systems, notably in hot dry rock,
for geothermal facilities for inter-seasonal heat storage in aquifers,
or for oil deposit exploitation, notably via enhanced oil recovery techniques.

13. A process or reducing or eliminating hydraulic short circuits between an injection well and a production well through a geological formation zone, comprising carrying out the process according to claim 1.

14. A process for geothermal exploitation for deep or shallow aquifer systems, for very deep high-energy geothermal systems, notably in hot dry rock, for geothermal facilities for inter-seasonal heat storage in aquifers, or for oil deposit exploitation, comprising carrying out the process according to claim 1.
